(19) United States
(12) Patent Application Publication
(10) Pub. No.: US 2024/0250914 A1
(43) Pub. Date: Jul. 25, 2024

(54) SYSTEM AND METHOD FOR POPULATING A QUEUE

(71) Applicant: The Toronto-Dominion Bank, Toronto (CA)

(72) Inventors: Axel Smith SCHON, Toronto (CA); Michaela DENG, Toronto (CA); Mohamed Mohsen ELMOSELHY, Mississauga (CA)

(73) Assignee: The Toronto-Dominion Bank, Toronto (CA)

(21) Appl. No.: 18/159,138

(22) Filed: Jan. 25, 2023

(51) Int. Cl. H04L 47/625; H04L 47/12

(52) U.S. Cl. CPC H04L 47/6255; H04L 47/12

(57) ABSTRACT

A computer server system comprises a communications module; a processor coupled with the communications module; and a memory coupled to the processor and storing processor-executable instructions which, when executed by the processor, configure the processor to identify a volume target for a queue based on a recent queue throughput; select a rule set based on the volume target and at least one other parameter; and implement the selected rule set to populate the queue.

### TECHNICAL FIELD

The present application relates to systems and methods for populating a queue.

### BACKGROUND

A queue is a linear data structure that includes a collection of entities maintained in a sequence and modified by the addition of entities at one end of the sequence and the removal of entities from the other end of the sequence. The entities may include data, objects, etc. that are stored in the queue and held to be processed later.

The operations of a queue may include a first-in-first-out (FIFO) data structure where the first entity added to the queue is the first one to be removed for processing. Oftentimes, a queue may be overloaded and as a result some entities stored in the queue may not be timely removed for processing. Entities that are not timely removed for processing may be removed from the queue without being processed.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a simplified schematic diagram showing components of a computing device;

FIG. 3 is a high-level schematic diagram of an example computer device;

FIG. 4 shows a simplified organization of software components stored in a memory of the example computer device of FIG. 3;

FIG. 5 is a flowchart showing operations performed for populating a queue; and

FIG. 6 is a flowchart showing operations performed for re-populating a queue.

Like reference numerals are used in the drawings to denote like elements and features.

### DETAILED DESCRIPTION OF VARIOUS EMBODIMENTS

Accordingly, in one aspect there is provided a computer server system comprising a communications module; a processor coupled with the communications module; and a memory coupled to the processor and storing processor-executable instructions which, when executed by the processor, configure the processor to identify a volume target for a queue based on a recent queue throughput; select a rule set based on the volume target and at least one other parameter; and implement the selected rule set to populate the queue.

In one or more embodiments, the instructions, when executed by the processor, configure the processor to detect a change in the recent queue throughput; and responsive to detecting the change in the recent queue throughput identify an updated volume target for the queue based on the change in the recent queue throughput; select the rule set based on the updated volume target and the at least one other parameter; and implement the selected rule set to re-populate the queue.

In one or more embodiments, the rule set is selected based on linear programming.

In one or more embodiments, the queue includes a secondary review queue.

In one or more embodiments, the queue is associated with a particular data bucket

In one or more embodiments, the at least one other parameter is detected fraud value and the rule set is selected to maximize the detected fraud value based on the volume target.

In one or more embodiments, the instructions, when executed by the processor, configure the processor to prior to selecting the rule set, determine a total amount of expected fraud value for each available rule set.

In one or more embodiments, the queue is populated with a plurality of entities.

In one or more embodiments, the entities include data transfers flagged as being potentially fraudulent.

In one or more embodiments, the volume target includes a count of data transfers.

According to another aspect there is provided a computer-implemented method comprising identifying a volume target for a queue based on a recent queue throughput; selecting a rule set based on the volume target and at least one other parameter; and implementing the selected rule set to populate the queue.

In one or more embodiments, the method further comprises detecting a change in the recent queue throughput; and responsive to detecting the change in the recent queue throughput identifying an updated volume target for the queue based on the change in the recent queue throughput; selecting the rule set based on the updated volume target and the at least one other parameter; and implementing the selected rule set to re-populate the queue.

In one or more embodiments, the rule set is selected based on linear programming.

In one or more embodiments, the queue includes a secondary review queue.

In one or more embodiments, the queue is associated with a particular data bucket.

In one or more embodiments, the at least one other parameter is detected fraud value and the rule set is selected to maximize the detected fraud value based on the volume target.

In one or more embodiments, the method further comprises, prior to selecting the rule set, determining a total amount of expected fraud value for each available rule set.

In one or more embodiments, the queue is populated with a plurality of entities that include data transfers flagged as being potentially fraudulent.

In one or more embodiments, the volume target includes a count of data transfers.

According to another aspect there is provided a non-transitory computer readable storage medium comprising processor-executable instructions which, when executed, configure a processor to identify a volume target for a queue based on a recent queue throughput; select a rule set based on the volume target and at least one other parameter; and implement the selected rule set to populate the queue.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

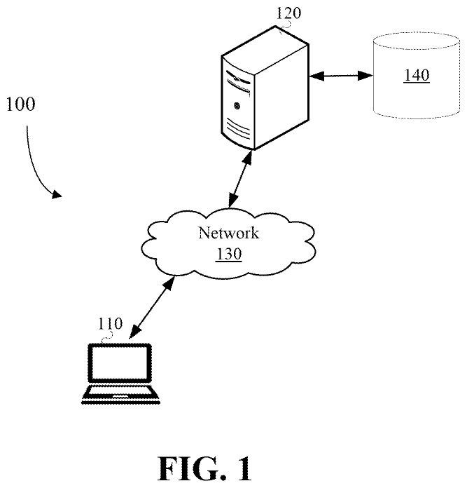

FIG. 1 is a schematic operation diagram illustrating an operating environment of an example embodiment. As shown, the system 100 includes a computing device 110 and a server computer system 120 coupled to one another through a network 130, which may include a public network such as the Internet and/or a private network. The computing device 110 and the server computer system 120 may be in geographically disparate locations. Put differently, the computing device 110 and the server computer system 120 may be located remote from one another.

The computing device 110 may be a personal computer as shown in FIG. 1. However, the computing device 110 may be a computing device of another type such as for example a laptop computer, a mobile device, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The server computer system 120 is a computer server system. A computer server system may for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

The server computer system 120 may communicate with a database 140 that may store entities such as for example data, objects, etc. for processing. The server computer system 120 may maintain one or more queues that are stored in the database 140. Specifically, the server computer system 120 may populate one or more queues with one or more of the entities.

In one or more embodiments, only a portion of the entities may be selected for processing. In these embodiments, the server computer system 120 may select the portion of the entities for processing based on one or more rule sets. As will be described in more detail, the server computer system 120 may evaluate a number of predefined rule sets to determine which rule sets, if implemented, will not overload the one or more queues.

In one or more embodiments, the server computer system 120 may monitor queue throughput. The queue throughput may be based on how many entities have been removed from a particular queue and processed within a particular time period.

In one or more embodiments, the computing device 110 may be adapted to receive, from the server computer system 120, one or more entities from one or more of the queues for processing.

In one or more embodiments, the server computer system 120 may be associated with a financial institution. In these embodiments, the entities stored in the database 140 may include data transfers. The server computer system 120 may select one or more of the data transfers for processing and this may be based on one or more rule sets for flagging data transfers as being potentially fraudulent. The data transfers selected for processing may be categorized into data buckets based on, for example, fraud value and each data bucket may be used to populate a particular queue.

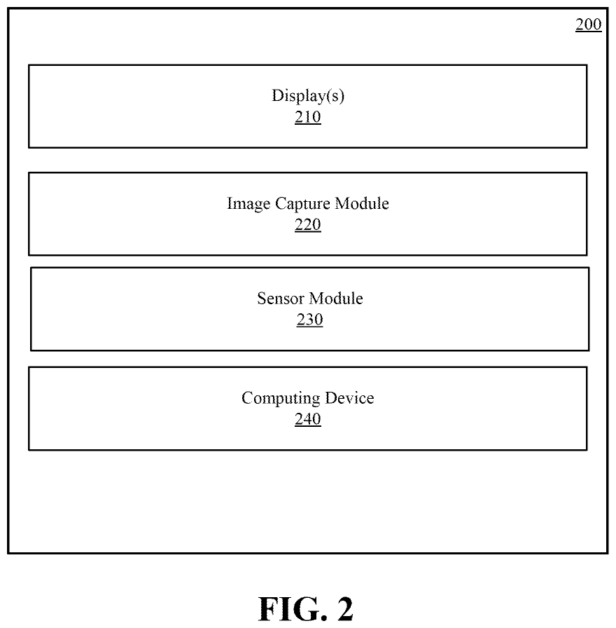

FIG. 2 is a simplified schematic diagram showing components of an exemplary computing device 200. The computing device 110 may be of the same type as computing device 200. The computing device 200 may include modules including, as illustrated, for example, one or more displays 210, an image capture module 220, a sensor module 230, and a computer device 240.

The one or more displays 210 are a display module. The one or more displays 210 are used to display screens of a graphical user interface that may be used, for example, to communicate with the server computer system 120 (FIG. 1). The one or more displays 210 may be internal displays of the computing device 200 (e.g., disposed within a body of the computing device).

The image capture module 220 may be or may include a camera. The image capture module 220 may be used to obtain image data, such as images. The image capture module 220 may be or may include a digital image sensor system as, for example, a charge coupled device (CCD) or a complementary metal-oxide-semiconductor (CMOS) image sensor.

The sensor module 230 may be a sensor that generates sensor data based on a sensed condition. By way of example, the sensor module 230 may be or include a location subsystem which generates location data indicating a location of the computing device 200. The location may be the current geographic location of the computing device 200. The location subsystem may be or include any one or more of a global positioning system (GPS), an inertial navigation system (INS), a wireless (e.g., cellular) triangulation system, a beacon-based location system (such as a Bluetooth low energy beacon system), or a location subsystem of another type.

The computer device 240 is in communication with the one or more displays 210, the image capture module 220, and the sensor module 230. The computer device 240 may be or may include a processor which is coupled to the one or more displays 210, the image capture module 220, and/or the sensor module 230.

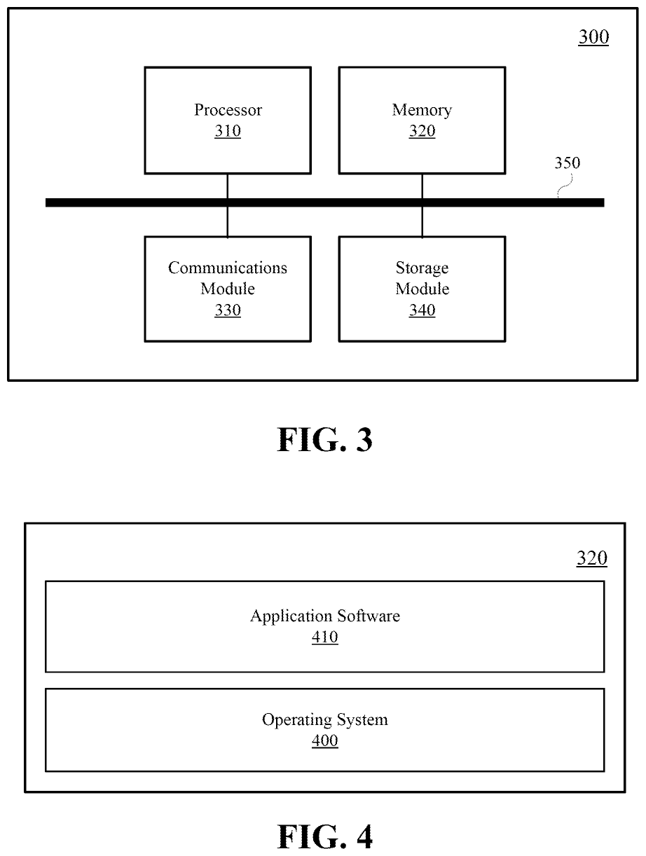

Referring now to FIG. 3, a high-level operation diagram of an example computer device 300 is shown. In some embodiments, the computer device 300 may be exemplary of the computer device 240 (FIG. 2) and/or server computer system 120.

The example computer device 300 includes a variety of modules. For example, as illustrated, the example computer device 300 may include a processor 310, a memory 320, a communications module 330, and/or a storage module 340. As illustrated, the foregoing example modules of the example computer device 300 are in communication over a bus 350.

The processor 310 is a hardware processor. The processor 310 may for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are non-transitory computer-readable storage mediums. A computer-readable medium may be organized using a file system such as may be administered by an operating system governing overall operation of the example computer device 300.

The communications module 330 allows the example computer device 300 to communicate with other computer or computing devices and/or various communications networks. For example, the communications module 330 may allow the example computer device 300 to send or receive communications signals. Communications signals may be sent or received according to one or more protocols or according to one or more standards. For example, the communications module 330 may allow the example computer device 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computer device 300 to communicate using near-field communication (NFC), via Wi-Fi™, using Bluetooth™ or via some combination of one or more networks or protocols. In some embodiments, all or a portion of the communications module 330 may be integrated into a component of the example computer device 300. For example, the communications module may be integrated into a communications chipset. In some embodiments, the communications module 330 may be omitted such as, for example, if sending and receiving communications is not required in a particular application.

The storage module 340 allows the example computer device 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the processor 310 in concert with the communications module 330 such as, for example, if data is stored remotely. The storage module may also be referred to as a data store.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 4 depicts a simplified organization of software components stored in the memory 320 of the example computer device 300 (FIG. 3). As illustrated, these software components include an operating system 400 and an application 410.

The operating system 400 is software. The operating system 400 allows the application 410 to access the processor 310 (FIG. 3), the memory 320, and the communications module 330 of the example computer device 300 (FIG. 3). The operating system 400 may be, for example, Google™ Android™, Apple™ iOS™, UNIX™, Linux™, Microsoft™ Windows™, Apple OSX™ or the like.

The application 410 adapts the example computer device 300, in combination with the operating system 400, to operate as a device performing a particular function. For example, the application 410 may cooperate with the operating system 400 to adapt a suitable embodiment of the example computer device 300 to operate as the computer device 240 (FIG. 2) and/or the server computer system 120.

While a single application 410 is illustrated in FIG. 3, in operation the memory 320 may include more than one application 410 and different applications 410 may perform different operations.

As mentioned, the server computer system 120 may maintain one or more queues that are populated with one or more entities. The server computer system 120 may remove entities from the queue for processing. In one or more embodiments, the server computer system 120 may provide the removed entities to one or more computing devices for processing. Each time a computing device has processed an entity, the server computer system 120 may remove a next entity from the queue and may provide the next entity to the computing device for processing.

The server computer system 120 may monitor queue throughput. The queue throughput may be based on how many entities have been removed from a particular queue and processed within a particular time period. In one or more embodiments, the queue throughput may include a rate at which entities are removed from the queue for processing and/or a count of entities that are removed from the queue for processing. The rate or the count may be determined over a particular time period which may be, for example, thirty (30) minutes or sixty (60) minutes.

The server computer system 120 may determine, in real-time, a recent queue throughput which may include a rate at which entities are removed from the queue for processing over the most recent time period and/or may include a count of entities that have been removed from the queue for processing during the most recent time period.

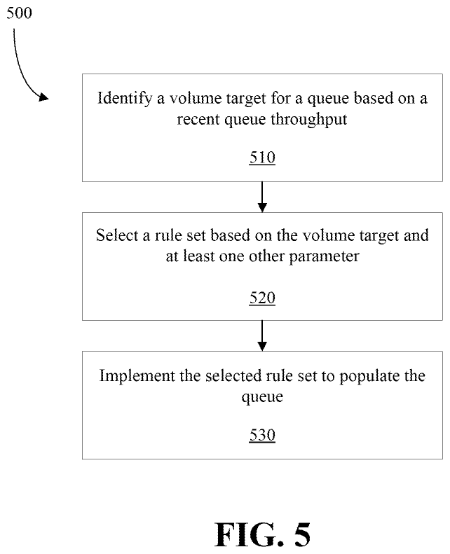

The server computer system 120 populates the one or more queues with one or more entities that are selected for processing. Reference is made to FIG. 5, which illustrates, in flowchart form, a method 500 for populating a queue. The method 500 may be implemented by a computing device having suitable processor-executable instructions for causing the computing device to carry out the described operations. The method 500 may be implemented, in whole or in part, by the server computer system 120. The server computer system 120 may offload some of the operations to the computing device 110.

The method 500 includes identifying a volume target for a queue based on a recent queue throughput (step 510).

As mentioned, the server computer system 120 monitors queue throughput and the most recent queue throughput may be used to identify the volume target. For example, the recent queue throughput may indicate that one thousand (1000) entities have been removed from the queue within the last thirty (30) minutes. As such, the volume target may be set as one thousand (1000) entities.

In one or more embodiments, the volume target may be based on additional criteria. For example, the recent queue throughput may have been dependent on how many computing devices are available to process the entities removed from the queue. For example, the recent queue throughput may indicate that five hundred (500) entities have been removed from the queue within the last thirty (30) minutes and that the five hundred (500) entities have been processed by five (5) computing devices. The server computer system 120 may determine that ten (10) computing devices are now available to process the removed entities and as such the server computer system 120 may set the volume target as one thousand (1000) entities. As another example, the recent queue throughput may indicate that one thousand (1000) entities have been removed from the queue within the last thirty (30) minutes and that the one thousand (1000) entities have been processed by ten (10) computing devices. The server computer system 120 may determine that five (5) computing devices are now available to process the removed entities and as such the server computer system 120 may set the volume target as five hundred (500) entities.

The method 500 includes selecting a rule set based on the volume target and at least one other parameter (step 520).

In one or more embodiments, the server computer system 120 may obtain a number of predefined rule sets to populate the queue. Each rule set may include one or more rules that may be implemented to populate the queue.

In one or more embodiments, the entities may include data files to be processed. In these embodiments, the rules may include predefined rules to prioritize the data files. For example, the predefined rules may include or may be based on a size of the data files, a priority of the data files, a source of the data files, a destination of the data files and/or a complexity of the data files.

In one or more embodiments, the entities may include data transfers. In these embodiments, the rules may include predefined rules known to detect potentially fraudulent data transfers. For example, the predefined rules may include or may be based on a geographic location of a transferor of the data transfer, a geographic location of a transferee of the data transfer, an amount of the data transfer, a data transfer history for the transferor and/or the transferee and/or whether the transferee is a new transferee.

In one or more embodiments, the at least one other parameter may include detected fraud value and the rule set may be selected to maximize the detected fraud value based on the volume target. In these embodiments, prior to selecting the rule set, the server computer system 120 may determine a total amount of expected fraud value for each available rule set. For example, the server computer system 120 may engage a forward selection algorithm to evaluate each available rule set to determine the fraud value expected to be detected using that particular rule set based on the entities stored in the database 140.

To select the rule set, the server computer system 120 may utilize linear programming to assign a rule set to the queue. In one or more embodiments, the linear programming may be utilized to maximize the detected fraud value based on the volume target. Put another way, the server computer system 120 may analyze the rule sets to select the rule set that maximizes the detected fraud value for the volume target. The linear programming may select the rule set, in at least some embodiments, to optimize for detected fraud value and the volume target.

The method 500 includes implementing the selected rule set to populate the queue (step 530).

Once the rule set has been selected, the server computer system 120 performs operations according to the selected rule set to populate the queue with the entities. The server computer system 120 ensures that the number of entities populated in the queue is less than the volume target and this ensures no entities remain in the queue without being processed.

In manners described herein, the server computer system 120 populates a queue based on a volume target and at least one other parameter. In embodiments where the entities include data transfers, the server computer system 120 selects a rule set to maximize the amount of detected fraud while at the same time ensuring that the volume target is not exceeded.

The methods described herein improve upon conventional methods where entities that are not timely removed for processing are removed from the queue without being processed. For example, a rule set may be selected to ensure that the volume target is not exceeded and in this manner entities may be timely removed from the queue for processing.

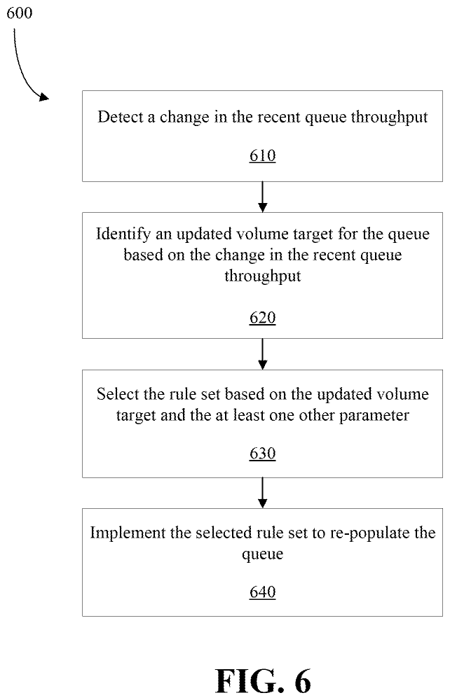

Once the queue has been populated with the entities, the server computer system 120 may continuously or periodically monitor the queue throughput and may perform operations to re-populate the queue. Reference is made to FIG. 6, which illustrates, in flowchart form, a method 600 for re-populating a queue. The method 600 may be implemented by a computing device having suitable processor-executable instructions for causing the computing device to carry out the described operations. The method 600 may be implemented, in whole or in part, by the server computer system 120. The server computer system 120 may offload some of the operations to the computing device 110.

The method 600 includes detecting a change in the recent queue throughput (step 610).

The server computer system 120 may monitor the queue throughput as described herein. In one or more embodiments, the server computer system 120 may periodically check the recent queue throughput such as for example every five (5) minutes.

The change in the recent queue throughput may be based on a comparison on the recent queue throughput and the previous queue throughput. For example, the server computer system 120 may determine a difference between the recent queue throughput and the previous queue throughput and may compare the difference to a threshold to detect the change in the recent queue throughput. For example, if the difference is greater than or equal to the threshold, the change in the recent queue throughput may be detected. Of course, if the difference is less than the threshold, the change in the recent queue throughput is not detected and as such the server computer system 120 may not perform operations to re-populate the queue until the change is detected.

The change in the recent queue throughput may be based on a comparison on the recent queue throughput and the queue throughput used to identify the volume target during step 510 of the method 500. For example, the server computer system 120 may determine a difference between the recent queue throughput and the queue throughput used to identify the volume target and may compare the difference to a threshold to detect the change in the recent queue throughput. For example, if the difference is greater than or equal to the threshold, the change in the recent queue throughput may be detected. Of course, if the difference is less than the threshold, the change in the recent queue throughput is not detected and as such the server computer system 120 may not perform operations to re-populate the queue until the change is detected.

The method 600 includes identifying an updated volume target for the queue based on the change in the recent queue throughput (step 620).

Responsive to detecting the change in the recent queue throughput, the server computer system 120 may identify an updated volume target based on the change in the recent queue throughput and this may be done in manners similar to that described herein with reference to step 510 of the method 500.

The method 600 includes selecting the rule set based on the updated volume target and the at least one other parameter (step 630).

The server computer system 120 may select the rule set based on the updated volume target and the at least one other parameter and this may be done in manners similar to that described herein with reference to step 520 of the method 500.

It will be appreciated that in embodiments there the selected rule set is the same rule set selected during step 520 of the method 500, the server computer system 120 may determine not to re-populate the queue and as such may not perform operations to re-populate the queue.

The method 600 includes implementing the selected rule set to re-populate the queue (step 640).

The server computer system 120 may implement the selected rule set to re-populate the queue and this may be done in manners similar to that described herein with reference to step 530 of the method 500. In one or more embodiments, entities that are already pending in the queue may be re-evaluated based on the selected rule set and may be removed from the queue or reassigned to a different queue as necessary.

It will be appreciated that the server computer system 120 may perform operations of the method 500 to populate more than one queue. For example, the server computer system 120 may categorize the entities stored in the database 140 into different entity buckets, where each entity bucket may be assigned to a particular queue. In examples where the entities include data transfers, the data transfers may be categorized into data buckets based on fraud value and may be assigned priority based on the fraud value. For example, the data transfers may be categorized into a “very high priority” data bucket, a “high priority” data bucket, a “medium priority” data bucket, a “low priority” data bucket or a “very low priority” data bucket and this may be done based on the value of the data transfer. The server computer system 120 may perform operations of the method 500 for each data bucket to populate a queue associated with each data bucket.

As another example, the server computer system 120 may select a rule set in manners similar to that described herein to populate a plurality of queues, where each queue may have a different priority. The server computer system 120 may select a rule set to populate a plurality of queues that may include a “very high priority” queue, a “high priority” queue, a “medium priority” queue, a “low priority” queue and/or a “very low priority” queue and this may be done using a particular rule set.

In manners described herein, where the server computer system 120 populates more than one queue, the rule set may be selected to maximize the likelihood that all of the entities stored in the “very high priority” queue are removed from processing and this may be based on the volume target. In one or more embodiments, the server computer system 120 may determine that that entities are frequently being removed from the “medium priority queue” this may trigger a condition indicating that there has been an increase in queue throughput and the server computer system 120 may perform operations to re-populate the queue based on one or more different rule sets similar to that described herein. Similarly, the server computer system 120 may determine that one or more entities in the “very high priority” queue are not being timely removed for processing, this may trigger a condition indicating that there has been a decrease in queue throughput and the server computer system 120 may perform operations to re-populate the queue based on one or more different rule sets similar to that described herein.

In one or more embodiments described herein, the queue that is populated by the server computer system 120 may include a secondary review queue. For example, the entities may include data transfers and the data transfers may pass through a filter, queue, etc. that may be configured to flag potentially fraudulent data transfers. The potentially fraudulent data transfers may be used to populate one or more queues in manners similar to that described herein and this may be done to prioritize which potentially fraudulent data transfers should be removed and sent to a computing device for processing or for further review.

Although in embodiments the server computer system is described as removing entities from one or more queues for processing by one or more computing devices, it will be appreciated that in one or more embodiments the entities may be processed by one or more processors associated with the server computer system or associated with a computing device. For example, a server computer system may include or may be connected to a plurality or processors such as for example virtual processors or logical processors. In this example, the server computer system may remove the entities for processing by one of the plurality of processors.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A computer server system comprising:
a communications module;
a processor coupled with the communications module; and
a memory coupled to the processor and storing processor-executable instructions which, when executed by the processor, configure the processor to:
identify a volume target for a queue based on a recent queue throughput;
select a rule set based on the volume target and at least one other parameter; and
implement the selected rule set to populate the queue.

2. The computer server system of claim 1, wherein the instructions, when executed by the processor, configure the processor to:
detect a change in the recent queue throughput; and
responsive to detecting the change in the recent queue throughput:
identify an updated volume target for the queue based on the change in the recent queue throughput;
select the rule set based on the updated volume target and the at least one other parameter; and
implement the selected rule set to re-populate the queue.

3. The computer server system of claim 1, wherein the rule set is selected based on linear programming.

4. The computer server system of claim 1, wherein the queue includes a secondary review queue.

5. The computer server system of claim 1, wherein the queue is associated with a particular data bucket.

6. The computer server system of claim 1, wherein the at least one other parameter is detected fraud value and the rule set is selected to maximize the detected fraud value based on the volume target.

7. The computer server system of claim 1, wherein the instructions, when executed by the processor, configure the processor to:
prior to selecting the rule set, determine a total amount of expected fraud value for each available rule set.

8. The computer server system of claim 1, wherein the queue is populated with a plurality of entities.

9. The computer server system of claim 8, wherein the plurality of entities includes data transfers flagged as being potentially fraudulent.

10. The computer server system of claim 1, wherein the volume target includes a count of data transfers.

11. A computer-implemented method comprising:
identifying a volume target for a queue based on a recent queue throughput;
selecting a rule set based on the volume target and at least one other parameter; and
implementing the selected rule set to populate the queue.

12. The method of claim 11, further comprising:
detecting a change in the recent queue throughput; and
responsive to detecting the change in the recent queue throughput:
identifying an updated volume target for the queue based on the change in the recent queue throughput;
selecting the rule set based on the updated volume target and the at least one other parameter; and
implementing the selected rule set to re-populate the queue.

13. The method of claim 11, wherein the rule set is selected based on linear programming.

14. The method of claim 11, wherein the queue includes a secondary review queue.

15. The method of claim 11, wherein the queue is associated with a particular data bucket.

16. The method of claim 15, wherein the at least one other parameter is detected fraud value and the rule set is selected to maximize the detected fraud value based on the volume target.

17. The method of claim 11, further comprising:
prior to selecting the rule set, determining a total amount of expected fraud value for each available rule set.

18. The method of claim 11, wherein the queue is populated with a plurality of entities that include data transfers flagged as being potentially fraudulent.

19. The method of claim 11, wherein the volume target includes a count of data transfers.

20. A non-transitory computer readable storage medium comprising processor-executable instructions which, when executed, configure a processor to:
identify a volume target for a queue based on a recent queue throughput;
select a rule set based on the volume target and at least one other parameter; and
implement the selected rule set to populate the queue.
